(19) United States
(12) Patent Application Publication
(10) Pub. No.: US 2012/0148256 A1
(43) Pub. Date: Jun. 14, 2012

(54) BIDIRECTIONAL OPTICAL SUB ASSEMBLY HAVING STRUCTURE TO REDUCE REFLECTION NOISE

(76) Inventors: Mi Hee HWANG, Gwangju (KR); Dong Jin Shin, Gwangju (KR); Suk Han Yun, Seoul (KR); Eun Kyo Jung, Gwangju (KR)

(21) Appl. No.: 13/176,706

(22) Filed: Jul. 5, 2011

(30) Foreign Application Priority Data
Dec. 14, 2010 (KR) 10-2010-0127670

(51) Int. Cl. H04B 10/02

(52) U.S. Cl. 398/136

(57) ABSTRACT

Disclosed herein is a bi-directional optical sub-assembly structured to reduce reflection noise. The bi-directional optical sub-assembly includes an optical fiber; a transmitter transmitting an optical transmit signal having passed through a 45° filter to the outside through the optical fiber, a receiver receiving an optical receive signal which is received from the outside through the optical fiber, is reflected by the 45° filter and passes through a 0° filter; a body encompassing a part of the optical fiber, a part of the transmitter and a part of the receiver; a cap housing encompassing a part of the transmitter and including an opening to provide a passage for the optical transmit signal from the transmitter to the optical fiber, and a filter holder having the 45° filter and the 0° filter attached thereon within the body. The opening of the cap housing is set to have a minimum diameter Xₘᵢₙ and a maximum diameter Xₘₐₓ so as to transmit the optical transmit signal without loss and to prevent the optical transmit signal from entering back to the transmitter after the optical transmit signal is reflected by the optical fiber, and the filter holder includes a first passage connected to the 45° filter and a second passage connected to the 0° filter. The first passage is set to have a predetermined filter holder size dₕ so as to prevent the optical transmit signal from entering the receiver after the optical transmit signal is reflected by the optical fiber.

### BACKGROUND OF THE INVENTION

1. Field of the Invention

The present invention relates to a bi-directional optical sub-assembly and, more particularly, to a bi-directional optical sub-assembly structured to reduce noise caused by optical reflection therein in order to reduce signal distortion.

2. Description of the Related Art

In optical fiber communications, a transceiver generally includes a transmitter using a laser diode (LD) and a receiver using a photodiode (PD). Recently, a single entity known as a bi-directional transceiver in which the transmitter and the receiver are combined is primarily used. A bi-directional optical sub-assembly (BOSA) refers to a structure equipped with the bi-directional transceiver as a main element.

FIG. 1 is a schematic diagram of a conventional bi-directional optical sub-assembly (BOSA). Referring to FIG. 1, the BOSA includes a transmitter 100, a cap housing 110, an isolator 120, a receiver 130, an optical fiber 140, an optical filter 150, a filter holder 160 and a body 170. An optical signal is output from a semiconductor laser diode as the transmitter 100 and is focused onto the optical fiber 160. A semiconductor photodiode as the receiver 130 receives the optical signal transmitted through the optical fiber 140.

For optical fiber communications using the semiconductor laser diode as a light source, the isolator 120 is interposed between the transmitter 100 and the optical fiber 140 to block reflection noise resulting from a part of the optical signal of the transmitter 100 which is reflected by optical elements or connectors and enters back to the transmitter 100.

The isolator 120 may include a polarizer, an analyzer and a Faraday rotator. The polarizer and the analyzer are only adapted to transmit a light component having a predetermined polarization, while the Faraday rotator rotates the polarizing direction of light by 45°.

Accordingly, an optical transmit signal output from the transmitter 100 propagates in a predetermined direction, is rotated by 45° in polarization direction when passing through the Faraday rotator of the isolator 120, and passes through the analyzer. In this ca a part of the optical transmit signal reflected by the optical fiber 140 or within the BOSA and proceeding towards the transmitter 100 is rotated by 45° in polarization by the Faraday rotator and is blocked by the polarizer.

In the case of long-distance signal transmission in optical fiber communications, scattering, absorption or dispersion of light reduces optical output, and internal noise causes distorted waveforms. Thus, since the internal noise degrades signal transmission quality in long-distance optical signal transmission, the BOSA needs the isolator 120 for long-distance signal transmission.

However, the isolator 120 is an expensive optical device, causing a BOSA module equipped with the isolator to be costly and causing extra manufacturing processes. Accordingly, a BOSA module capable of reducing reflection noise without the isolator 120 to prevent waveform distortion is increasingly demanded.

### SUMMARY OF THE INVENTION

The present invention is directed to solving the problems of the related art as described above, and one aspect of the present invention is to provide a bi-directional optical sub-assembly which is structured to reduce reflection noise without an isolator by optimally setting a diameter of an opening of a cap housing and a size of a passage for an optical transmit signal within a filter holder so as to reduce reflection noise generated when the optical transmit signal output from a transmitter is reflected by an optical fiber, the filter holder and so on and enters back to the transmitter, and providing an absorber on a part of a body to absorb light.

In accordance with one aspect of the present invention, a bi-directional optical sub-assembly structured to reduce reflection noise includes: an optical fiber; a transmitter transmitting an optical transmit signal having passed through a 45° filter to the outside through the optical fiber, a receiver receiving an optical receive signal which is received from the outside through the optical fiber, is reflected by the 45° filter and passes through a 0° filter: a body encompassing a part of the optical fiber, a part of the transmitter and a part of the receiver; a cap housing encompassing a part of the transmitter and including an opening to provide a passage for the optical transmit signal from the transmitter to the optical fiber: and a filter holder having the 45° filter and the 0° filter attached thereon within the body, wherein the opening of the cap housing is set to have a minimum diameter Xₘᵢₙ and a maximum diameter Xₘₐₓ so as to transmit the optical transmit signal without loss and to prevent the optical transmit signal from entering back to the transmitter after the optical transmit signal is reflected by the optical fiber, and the filter holder includes a first passage connected to the 45° filter and a second passage connected to the 0° filter, the first passage being set to have a predetermined filter holder size dₕ so as to prevent the optical transmit signal from entering the receiver after the optical transmit signal is reflected by the optical fiber.

The transmitter may be aligned with an optical axis of the optical transmit signal which is incident on the optical fiber.

The minimum diameter Xₘᵢₙ of the opening may be expressed by Equation 2:

Xₘᵢₙ=2×((f−D−L)×tan θ),

where D is a distance between a lens cap of the transmitter and the opening, F is a focal distance of a lens of the transmitter, L is a height of the lens cap of the transmitter, and θ is an angle of light radiating from the lens.

The maximum diameter Xₘₐₓ of the opening may be expressed by the following equation: Xₘₐₓ=Xₘᵢₙ+300 μm.

The predetermined filter holder size dₕ may range from 0.4 mm to 0.6 mm.

The body may further include an absorber to absorb the optical transmit signal which is reflected by the optical fiber and reaches an inner wall of the body.

An inclined surface of the optical fiber may be inclined in the same direction as the filter holder to allow light reflected therein to proceed to an absorber.

### BRIEF DESCRIPTION OF THE DRAWINGS

The above and other aspects, features and other advantages of the present invention will be more clearly understood from the following detailed description taken in conjunction with the accompanying drawings:

FIG. 1 is a schematic diagram illustrating a conventional bi-directional optical sub-assembly;

FIG. 2 is a schematic diagram of a bi-directional optical sub-assembly according to an exemplary embodiment of the present invention;

FIG. 3 is a cross-sectional view of an opening of a cap housing in a bi-directional optical sub-assembly according to an exemplary embodiment of the present invention;

FIG. 4A is a cross-sectional view of a filter holder in a bi-directional optical sub-assembly according to an exemplary embodiment of the present invention;

FIG. 4B is a cross-sectional view of a filter holder in a bi-directional optical sub-assembly according to another exemplary embodiment of the present invention;

FIG. 5 illustrates a central axis of a transmitter and an alignment axis of an optical fiber which are aligned with each other according to an exemplary embodiment of the present invention;

FIGS. 6A and 6B illustrate eve diagrams for a bi-directional optical sub-assembly not equipped with an isolator;

FIG. 6C illustrates an eye diagram for a bi-directional optical sub-assembly structured to reduce reflection noise according to an exemplary embodiment of the present invention;

FIG. 7A illustrates simulated optical paths;

FIG. 7B illustrates simulated optical paths when an optical fiber and a filter holder face in opposite directions according to an exemplary embodiment of the present invention; and

FIG. 7C illustrates simulated optical paths when an optical fiber and a filter holder face in the same direction according to another exemplary embodiment of the present invention.

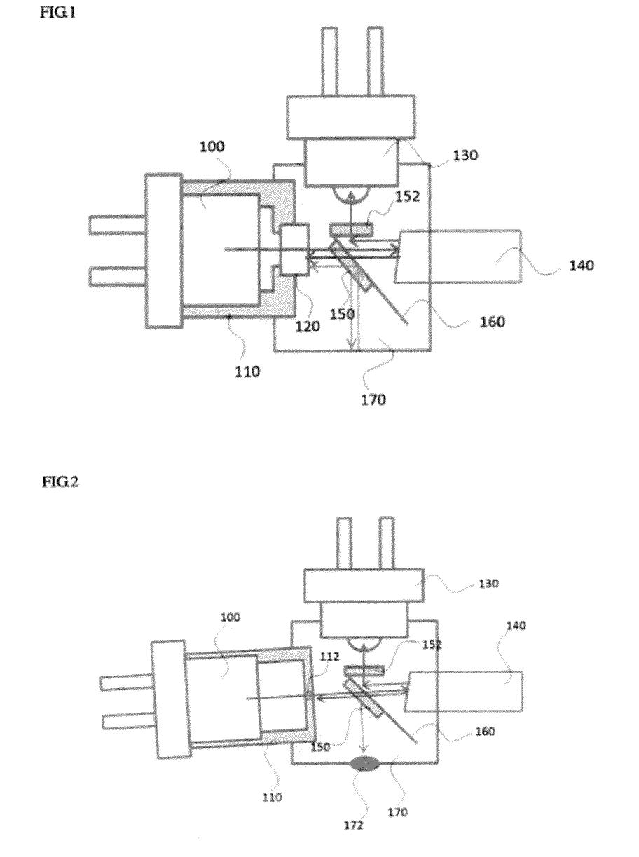

### DESCRIPTION OF THE PREFERRED EMBODIMENTS

Preferred embodiments will now be described in detail with reference to the accompanying drawings.

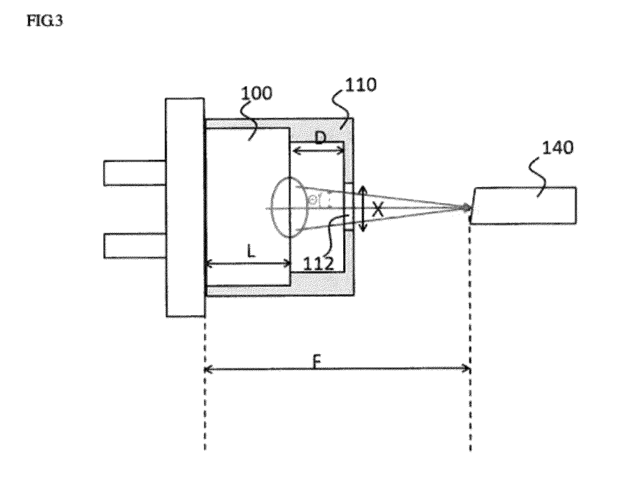

FIG. 2 is a schematic diagram of a bi-directional optical sub-assembly according to an exemplary embodiment of the present invention. Referring to FIG. 2, the bi-directional optical sub-assembly structured to reduce reflection noise may include a transmitter 100, a cap housing 110, an opening 112, a receiver 130, an optical fiber 140, optical filters 150 and 152, a filter holder 160, a body 170, and an absorber 172.

The transmitter 100 outputs and transmits an optical transmit signal through the optical fiber 140. The transmitter 100 may include a laser diode (LD).

The cap housing 110 is provided to encompass the transmitter 100 and may include the opening 112 as a passage for the optical transmit signal from the transmitter 100 to be transmitted to the optical fiber 140.

The opening 112 serves as a passage for the optical transmit signal from the transmitter 100 to pass through the cap housing 110 so that the optical transmit signal may be transmitted to the optical fiber 140. The opening 112 may be provided on a part of the cap housing 110. The opening 112 needs to be designed to have a diameter equal to or greater than the size of the optical transmit signal so that the optical transmit signal may pass through the opening 112 without loss. Further, the size of the opening 112 needs to be not greater than a maximum diameter of the opening 112 in order to prevent the optical transmit signal reflected by the optical fiber 140 from entering back to the transmitter 100 through the opening 112. Design conditions as to the diameter X of the opening 112 will be described in detail.

The receiver 130 may receive an optical receive signal transmitted through the optical fiber 140 for optical fiber communication. The receiver 130 may include a photodiode.

The optical filters may include a 45° filter 150 and a 0° filter 152. The 45° filter 150 transmits the optical transmit signal from the transmitter 100 and reflects the optical receive signal received through the optical fiber 140 onto the 0° filter 152. The 0° filter 152 transmits the reflected optical receive signal to the receiver 130.

The optical fiber 140 may include a core and a cladding (not shown) surrounding the core. The optical fiber 140 acts as a light pipe to transmit the optical transmit signal in the core and the cladding over a short or long distance. The cladding is generally coated with resin to protect a glass surface. The optical fiber 140 may have different functions or characteristics depending on use and be differently designed depending on design requirements.

The filter holder 160 may have the 45° filter 150 and the 0° filter 152 attached thereto. The filter holder 160 may be configured in such a manner that a predetermined part of the optical fiber 140 is inserted into and combined with the filter holder 160. The filter holder 160 may include a first passage 162, which is connected to the 45° filter 150 for the optical transmit signal to pass therethrough, and a second passage 164, which is connected to the 0° filter 152 for the optical receive signal to pass therethrough. In order to prevent the optical transmit signal passing through the 45° filter 150 from being reflected by the optical fiber 140 and entering the receiver 130, the size of the first passage 162 may be set to a predetermined filter holder size dₕ. Calculation of the filter holder size will be described in detail.

The body 170 may be formed to encompass a part of the cap housing 110, a part of the receiver 130, a part of the optical fiber 140, the optical filters 150 and 152, and the filter holder 160. The body 170 may be configured so that the optical transmit signal or the optical receive signal may not leak. The body 170 may include an absorber 172 to absorb the optical transmit signal or the optical receive signal which is reflected therein.

The absorber 172 may be formed from at least one of Cu, Cr, Mo, Fe, Ni, amorphous Si, SiC, Ge, WSi₂, Ti, TiN, Ta, TiW, Co, SiGe, TiSi₂, CrSi₂, MoSi₂, FeSi₂, CoSi₂, NiSi₂, CrN and Mo₂N, each having a high absorption coefficient, to absorb the reflected optical transmit signal or the reflected optical receive signal.

Hence, according to an exemplary embodiment of the present invention, the bi-directional optical sub-assembly not equipped with an isolator 120 may be configured to reduce reflection noise occurring therein, thereby manufacturing a BOSA module at a lower price and through a simpler process.

FIG. 3 is a schematic diagram illustrating an opening of a cap housing in a bi-directional optical sub-assembly according to an exemplary embodiment of the present invention. Referring to FIG. 3, in order to transmit an optical transmit signal from the transmitter 100 through the cap housing 110 without loss and to suppress the transmitted optical transmit signal from being reflected by the optical fiber 140 and entering back to the transmitter 100, the opening 112 of the cap housing 110 may be designed to have a diameter X depending on the size of the optical transmit signal.

The size of the optical transmit signal may be calculated from Equation 1:

Xₘᵢₙ=2×((F−D−L)×tan θ),

where F is focal distance, D is distance between a lens cap of the transmitter and the opening, L is a height of the lens cap, and θ is an angle of light radiating from the lens cap of the transmitter.

The minimum diameter Xₘᵢₙ of the opening 112 represents a minimum value of the opening 112 for the optical tram signal to pass through the cap housing 110 without loss. Hence, the minimum diameter Xₘᵢₙ of the opening 112 needs to be designed to be equal to or greater than the size of the optical transmit signal.

However, if the diameter X of the opening 112 is too large, the optical transmit signal reflected by the optical fiber 140 may enter back to the transmitter 100 through the opening 112. Hence, the diameter X of the opening 112 needs to be designed to be not greater than the maximum diameter Xₘₐₓ of the opening 112.

The maximum diameter Xₘₐₓ of the opening 112 may be designed to be about 200-300 μm greater than the minimum diameter Xₘᵢₙ of the opening 112.

For instance, when the optical transmit signal passes through a lens (for example, its focal distance is 10.18 mm and NA (on the optical fiber side) is 0.1) positioned at a front end of the transmitter 100 and is focused onto the optical fiber 140, the angle θ of the optical transmit signal is generally ±5.73°. If a distance D between a cap of a lens included in the transmitter 100 and the opening 112 is 3 mm, the size of the optical transmit signal passing through the opening 112 is calculated to be 660 μm. In this case, since the diameter X of the opening 112 needs to be equal to or greater than the size of the optical transmit signal, the diameter X of the opening 112 needs to be 660 μm or greater. If the diameter X of the opening 112 is smaller than the size of the optical transmit signal (for example, 660 μm), the optical transmit signal fails to pass through the opening 112 without loss and is reflected, which may result in waveform distortion.

On the other hand, the maximum diameter Xₘₐₓ of the opening 112 may be 300 μm greater than the minimum diameter Xₘᵢₙ of the opening 112. If the maximum diameter Xₘₐₓ of the opening 112 is designed to be over 300 μm greater than the minimum diameter Xₘᵢₙ, the optical transmit signal reflected by the optical fiber 140 enters back to the transmitter 100, thereby generating reflection noise.

Accordingly, the opening 112 may be designed to have a diameter X ranging from 0.7 mm to 1 mm. In this case, the optical transmit signal may pass through the opening 112 without loss. Further, the optical transmit signal may be suppressed from being reflected by the optical fiber 140 and entering back to the opening 112, thereby reducing signal distortion due to reflection noise.

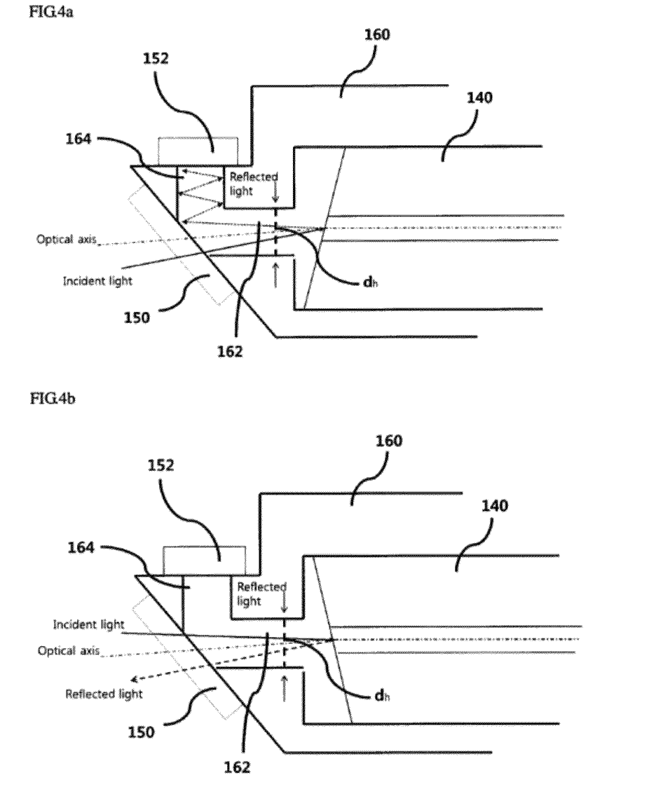

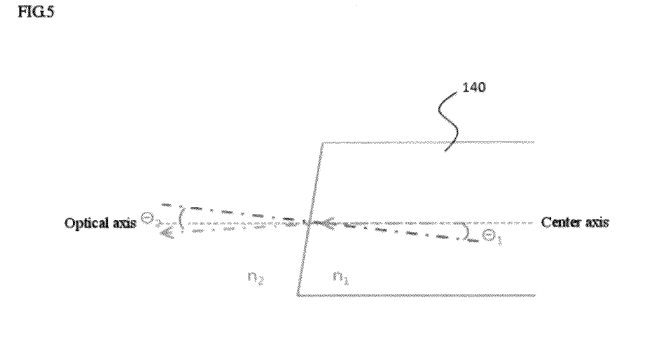

FIG. 4A is a cross-sectional view of a filter holder in a bi-directional optical sub-assembly according to an exemplary embodiment of the present invention. Referring to FIG. 4A, if incident light of an optical transmit signal passing through the 45° filter 150 and the first passage 162 is not incident on a core of the optical fiber 140, the incident light is reflected by the optical fiber 140 and proceeds to the receiver 130 through the second passage 164 which is a passage of the 0° filter 152. In order to prevent the optical transmit signal reflected by the optical fiber 140 from entering the receiver 130, a filter holder size dₕ of the first passage 162 which is a passage of the 45° filter 150 needs to have a predetermined value.

More specifically, the optical transmit signal output from the transmitter 100 has a certain size after passing through the 45° filter 150. The filter holder size of the first passage 162 is determined depending on the position of the filter holder 160. The filter holder size of the first passage 162 may be designed to be a determined filter holder size dₕ. The filter holder size dₕ may be set to 0.4 to 0.6 mm.

Accordingly, when the optical transmit signal passes through the filter holder 160 and is incident on the optical fiber 140, reflection noise may be reduced by setting the first passage 162 of the filter holder 160 to the predetermined filter holder size dₕ, thereby decreasing signal distortion.

FIG. 4B is a cross motional view of a filter holder in a bi-directional optical sub-assembly according to another exemplary embodiment of the present invention. Referring to FIG. 4B, as compared to FIG. 4A, it should be noted that the optical fiber 140 inserted into the filter holder 160 has an inclined surface rotated by 180°.

That is, referring to FIG. 4A, the inclined surface of the optical fiber 140 may generally be designed to be inclined in a reverse direction to a 45° surface of the filter holder 160, thereby minimizing reflection noise. Further, referring to FIG. 4B, if the inclined surface of the optical fiber 140 is rotated by 180° in the reverse direction, light reflected by the optical fiber 140 may be directed to the absorber rather than to the photodiode, thereby further reducing internal reflection.

FIG. 5 illustrates a central axis of the transmitter and an alignment axis of the optical fiber which are aligned with each other. Referring to FIG. 5, the optical fiber 140 has an end surface which is inclined by a certain angle in order to reduce internal reflection in the BOSA. In this case, the inclined angle is typically 6° or 8°.

Light propagating from air to the optical fiber 140 or vice versa is subject to refraction according to Snell's law since the optical fiber 140 and the air have different indexes of refraction.

More specifically, if the transmitter 140 is aligned with the central axis of the optical fiber 140, there exists an optical transmit signal which is not focused onto a core of the optical fiber 140 since the optical axis of the optical transmit signal radiating from the transmitter 100 is different in angle from the central axis of the optical fiber 140. Such an optical transmit signal is reflected and enters back to the transmitter 100, thereby acting as reflection noise to an optical transmit signal.

Accordingly, the transmitter 100 needs to be aligned with the optical axis to suppress the optical transmit signal from being reflected onto the transmitter 100. For example, if the optical fiber 140 is inclined by 8° the optical axis is deviated by 3.64° from the central axis. Accordingly, if the transmitter 100 is aligned to be inclined by 3.64° from the central axis, reflection of the optical transmit signal due to the difference in angle of the optical axis from the central axis of the optical fiber 140 may be reduced.

TABLE 1

| | Optical fiber inclined by 8° | Optical fiber inclined by 6° |
|---|---|---|
| Snell's Law | 1.45 × sin 8° = 1 × sin θ₁ | 1.45 × sin 6° = 1 × sin θ₁ |
| | θ₁ = 11.64° | θ₁ = 8.71° |
| Optical Axis | Deviated from the | Deviated from the |
| | central axis by 3.64° | central axis by 2.71° |

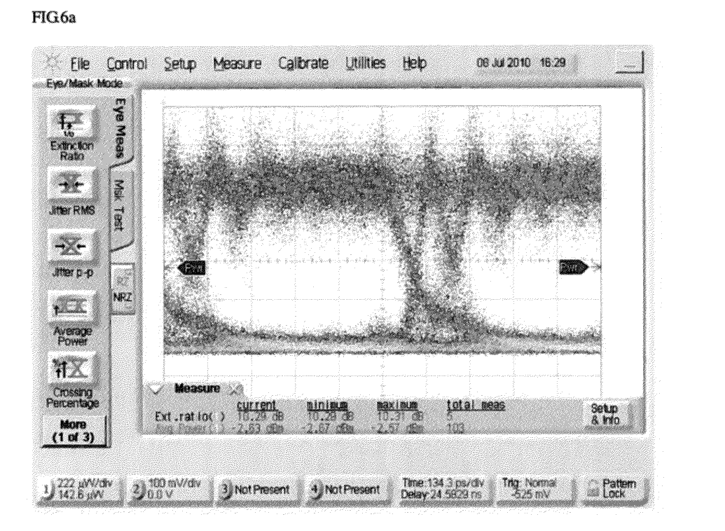

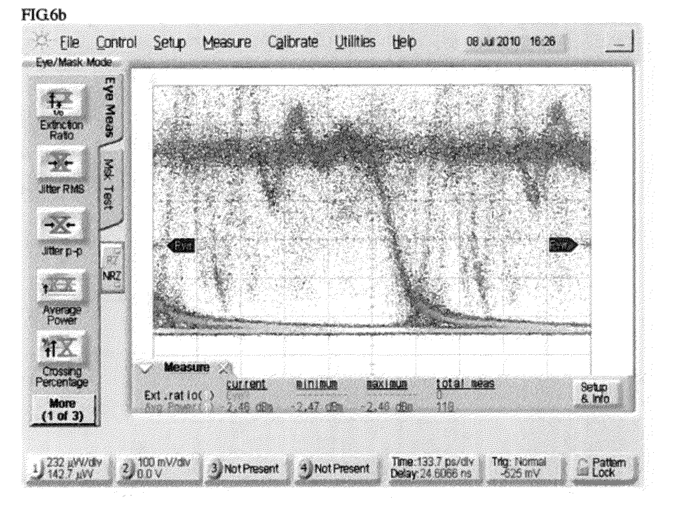

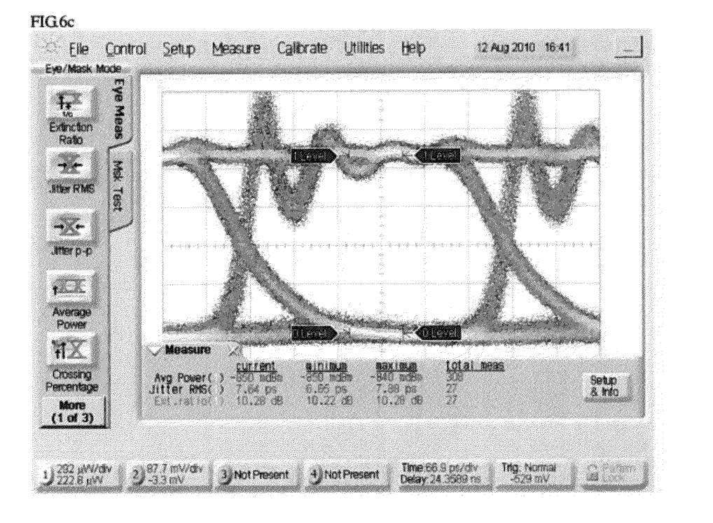

FIGS. 6A and 6B illustrate eye diagrams for the bi-directional optical sub-assembly not equipped with an isolator. Referring to FIGS. 6A and 6B, reflection noise accounts for unstable eye diagrams. It can be seen from the eye diagrams that the optical transmit signal or the optical receive signal has significantly been affected by the reflection noise. That is, as described above, the reflection noise causes signal distortion.

FIG. 6C illustrates an eye diagram for the bi-directional optical sub-assembly structured to reduce reflection noise according to an exemplary embodiment of the invention. It can be seen from FIG. 6C that the eye diagram is stable. That is, the exemplary bi-directional optical sub-assembly reduces reflection noises, thereby significantly reducing signal distortion.

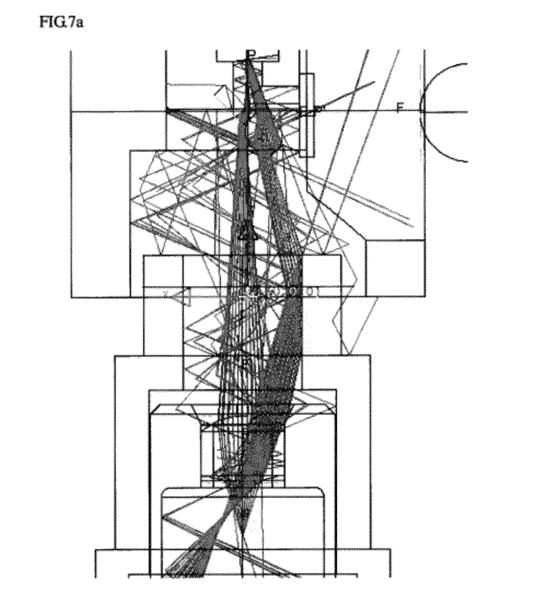

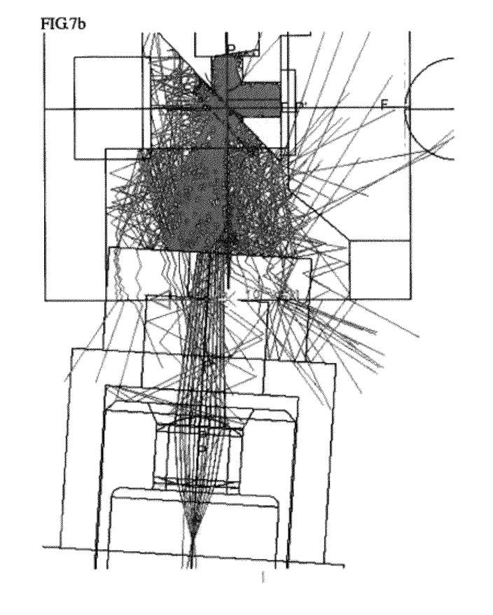

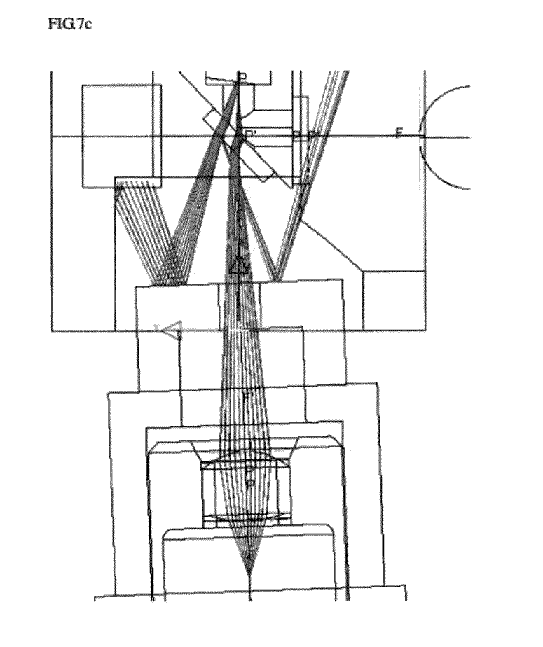

FIG. 7A illustrates simulated optical paths of a conventional BOSA. It can be seen from FIG. 7A that when light output from the transmitter (on the left of FIG. 7A) is reflected by the optical fiber (on the right of FIG. 7A), a great amount of the light enters back to the transmitter. That is, the conventional BOSA exhibits a great deal of reflection noise due to internal reflection.

HG. 7B illustrates simulated optical paths when the optical fiber and the filter holder face in opposite directions according to an exemplary embodiment of the present invention. As compared to FIG. 7A, it can be seen from FIG. 7B that when light output from the transmitter (on the left of FIG. 7B) is reflected by the optical fiber (on the right of FIG. 7B), an amount of light entering back to the transmitter has been significantly reduced. That is, since the exemplary bi-directional optical sub-assembly is structured to reduce internal reflection, reflection noise is significantly reduced.

FIG. 7C illustrates simulated optical paths when the optical fiber and the filter holder face in the same direction according to another exemplary embodiment of the invention. As compared to FIG. 7A, it can be seen from FIG. 7C that when light output from the transmitter (on the left of FIG. 7C) is reflected by the optical fiber (on the right of FIG. 7C), an amount of light entering back to the transmitter has been significantly reduced. Further, as compared to FIG. 7B, it can be seen from FIG. 7C that the inclined surface of the optical fiber 140 is designed to be rotated by 180 with respect to the inclined surface of the optical fiber 140 of FIG. 7B in order for light reflected therein to be transmitted to the absorber. In this case, it can be seen that internal reflection has significantly been reduced as compared to FIG. 7B.

Accordingly, the exemplary bi-directional optical sub-assembly is structured to significantly reduce reflection noise caused by internal reflection, thereby preventing waveform distortion.

As such, the bi-directional optical sub-assembly according to the exemplary embodiment of the present invention is structured to reduce reflection noise without the isolator by optimally setting the diameter of the opening of the cap housing and the size of the passage for the optical transmit signal within the filter holder so as to reduce reflection noise generated when the optical transmit signal output from the transmitter is reflected by the optical fiber, the filter holder and so on and enters back to the transmitter, and providing the absorber on a part of the body to absorb the light.

It should be understood that the embodiments and the accompanying drawings have been described for illustrative purposes, and the present invention is limited only by the following claims. Further, those skilled in the art will appreciate that various modifications, additions and substitutions are possible without departing from the scope and spirit of the invention according to the accompanying claims.

What is claimed is:

1. A bi-directional optical sub-assembly structured to reduce reflection noise, comprising:
an optical fiber,
a transmitter transmitting an optical transmit signal having passed through a 45° filter to the outside through the optical fiber,
a receiver receiving an optical receive signal which is received from the outside through the optical fiber, is reflected by the 45° filter and passes through a 0° filter,
a body encompassing a part of the optical fiber, a part of the transmitter and a part of the receiver;
a cap housing encompassing a part of the transmitter and including an opening to provide a passage for the optical transmit signal from the transmitter to the optical fiber, and
a filter holder having the 45° filter and the 0° filter attached thereon within the body,
wherein the opening of the cap housing is set to have a minimum diameter Xₘᵢₙ and a maximum diameter Xₘₐₓ so as to transmit the optical transmit signal without loss and to prevent the optical transmit signal from entering back to the transmitter after the optical transmit signal is reflected by the optical fiber, and
the filter holder includes a first passage connected to the 45° filter and a second passage connected to the 0° filter, the first passage being set to have a predetermined filter holder size dₕ so as to prevent the optical transmit signal from entering the receiver after the optical transmit signal is reflected by the optical fiber.

2. The bi-directional optical sub-assembly according to claim 1, wherein the transmitter is aligned with an optical axis of the optical transmit signal which is incident on the optical fiber.

3. The bi-directional optical sub-assembly according to claim 1, wherein the minimum diameter Xₘᵢₙ of the opening is expressed by Equation 1:
Xₘᵢₙ=2×((F−D−L)×tan θ),
where D is a distance between a lens cap of the transmitter and the opening, F is a focal distance of a lens of the transmitter, L is a height of the lens cap of the transmitter, and θ is an angle of light radiating from the lens.

4. The bi-directional optical sub-assembly according to claim 3, wherein the maximum diameter Xₘₐₓ of the opening is expressed by Equation 2:
Xₘₐₓ=Xₘᵢₙ+300 μm

5. The bi-directional optical sub-assembly according to claim 1, wherein the predetermined filter holder site dₕ ranges from 0.4 mm to 0.6 mm.

6. The bi-directional optical sub-assembly according to claim 1, wherein the body further includes an absorber to absorb the optical transmit signal which is reflected by the optical fiber and reaches an inner wall of the body.

7. The bi-directional optical sub-assembly according to claim 1, wherein an inclined surface of the optical fiber is inclined in the same direction as the filter holder to allow light reflected therein to proceed to an absorber.
